(19) United States
(12) Patent Application Publication
(10) Pub. No.: US 2005/0245352 A1
(43) Pub. Date: Nov. 3, 2005

(54) Method for operating an axhaust gas treatment device

(76) Inventors: Andreas Pfaeffle, Wuestenrot (DE); Michael Kolitsch, Weissach (DE); Andreas Schaffrath, Korntal-Muenchingen (DE)

Correspondence Address: KENYON & KENYON, ONE BROADWAY, NEW YORK, NY, 10004, US

(21) Appl. No.: 11/045,175

(22) Filed: Jan. 27, 2005

(30) Foreign Application Priority Data
Apr. 30, 2004 (DE) 102004021373.9

(51) Int. Cl. B60K 41/04

(52) U.S. Cl. 477/111

(57) ABSTRACT

A method for operating an exhaust gas treatment device of an internal combustion engine in which a change in the operating mode of the internal combustion engine is made as a function of a parameter. A timer is started in response to an operative mode change request. During the time period set by the timer, the system continuously decides, based on evaluation of at least one parameter, whether the change in operating mode can be made. If this is the case, the operative mode change is made immediately. If this is not the case, the operative mode change is made no later than when the time period set by the timer has expired. The method ensures that a driver of a motor vehicle in which the internal combustion engine is provided for propulsion will not notice a torque jump of the internal combustion engine, possibly occurring during an operative mode change.

### BACKGROUND INFORMATION

A method is described in German Patent Application No. DE 100 56 016, in which a regeneration is initiated as a function of a parameter of an exhaust gas treatment device. The temperature of the exhaust gas treatment device during regeneration depends, first of all, on the state of the exhaust gas treatment device and, secondly, on the operating state of the internal combustion engine. The regeneration of the exhaust gas treatment device is carried out, for example, by introducing unburned fuel into the exhaust tract of the internal combustion engine. The fuel reacts exothermically in an oxidation catalyst. The heated exhaust gases heat the exhaust gas treatment device to the starting temperature required for regeneration. The regeneration is divided into two phases. In the first phase, the quantity of unburned fuel in the exhaust gas increases in the course of time. In the second phase, the amount of unburned fuel is kept at least approximately constant. This measure, first of all, allows the temperature of the exhaust gas treatment device to increase according to a predetermined function, i.e., not too quickly and not too slowly. Secondly, a torque jump of the internal combustion engine, possibly occurring when changing the operating mode from normal operation to regeneration, is reduced to such an extent that it is no longer noticed by a driver of a motor vehicle in which the internal combustion engine is used for propulsion.

German Patent Application No. DE 100 56 034 describes a method for operating an exhaust gas treatment device in which a regeneration of the exhaust gas treatment device is carried out as a function of the operating state of the internal combustion engine. The loading of the exhaust gas treatment device with an exhaust gas component is determined and compared to a predetermined threshold value, which is changed as a function of the operating state of the internal combustion engine. If appropriate conditions exist, the exhaust gas treatment device is regenerated in advance before a permissible loading condition is reached. The state of the internal combustion engine can also be taken into account in the termination of the regeneration process. If the operating state of the internal combustion engine becomes unfavorable during regeneration, the regeneration is aborted.

An object of the present invention is to provide a method for operating an exhaust gas treatment device in which a possibly occurring torque jump of the internal combustion engine is prevented, to the extent possible, from being noticed by a driver of the motor vehicle.

### SUMMARY OF THE INVENTION

The method of the present invention for operating an exhaust gas treatment device of an internal combustion engine starts from the assumption that a change in the operating mode of the internal combustion engine is made as a function of a parameter. A timer is started in response to an operative mode change request. During the time period set by the timer, the system continuously decides, based on evaluation of at least one parameter, whether the change in operating mode can be made. If this is the case, the operative mode change is made immediately. However, the operative mode change is made no later than when the time period set by the timer has expired.

The exhaust gas treatment device can be, for example, a storage catalyst and/or a particulate filter. Both components store an exhaust gas component. From time to time, it is necessary to carry out a regeneration. At present, such a regeneration must be carried out at an elevated operating temperature as compared to normal operation. An increase in temperature can be achieved, for example, by introducing unburned fuel into the exhaust tract where it undergoes an exothermic reaction. Advantageously, the unburned fuel is provided in an intra-engine process by a change in the control of the internal combustion engine. Another possibility is to degrade the efficiency of the internal combustion engine in a controlled manner so as to increase the exhaust gas temperature. The intra-engine measures lead to a torque jump of the internal combustion engine, which is noticed by a driver of a motor vehicle in which the internal combustion engine is provided for propulsion.

The procedure of the present invention allows the operative mode change to be made without the possibly occurring torque jump being noticed by the driver.

The at least one parameter reflects an operating state of the internal combustion engine or of a motor vehicle. By evaluating the parameter, it is possible to detect a condition which allows to infer a change in the operating state of the internal combustion engine or in the driving state of the motor vehicle. Such a change, which is generally intended or noticed by the driver, can additionally be used to make the operative mode change.

The procedure of the present invention ensures that the requested operative mode change is made in any case no later than when the time period set by the timer has expired.

In one embodiment, the parameter provided is a signal indicative of a deceleration fuel cutoff of the internal combustion engine. Such a signal may be a desired torque value which is determined as a function of a position of an accelerator pedal of the motor vehicle. When no torque is requested, a deceleration fuel cutoff may possibly be carried out during which the fuel supply to the cylinders of the internal combustion engine is cut off or at least considerably reduced.

One embodiment provides that the parameter be indicative of a gear change in a transmission associated with the internal combustion engine. In the case of an automatic transmission, a power transmission signal is available which indicates a drive train interruption.

In one embodiment, it is provided that the parameter be indicative of a load on the internal combustion engine that exceeds a predetermined threshold. A high load on the internal combustion engine generally results in a high exhaust gas temperature so that an operative mode change from normal operation to regeneration at an elevated exhaust gas temperature can possibly be made with only a small intervention in the engine management. The load on the internal combustion engine can be determined, for example, from an available RPM signal and a fuel signal.

One embodiment provides that the parameter be indicative of a change in the dynamics of the internal combustion engine. Suitable signals are, for example, a desired torque value or, for example, the rotational speed. During accelerations or braking operations of the motor vehicle, the operative mode change will not be noticeable.

In a further refinement, the operative mode change to be made when the time period set by the timer has expired is made according to a predetermined function. For example, it is suitable to change at least one control variable of the internal combustion engine in a ramped manner.

It is possible, for example, to retard the timing of a main fuel injection. Alternatively or additionally, provision can be made for at least one post-injection of fuel. Alternatively or additionally, it is possible to drive a throttle valve in the direction of closure. As an alternative, or in addition, it is possible to reduce a boost pressure.

### BRIEF DESCRIPTION OF THE DRAWINGS

FIG. 1 shows a technical environment in which a method according to the present invention is executed.

FIG. 2 is a flow chart of the method.

### DETAILED DESCRIPTION

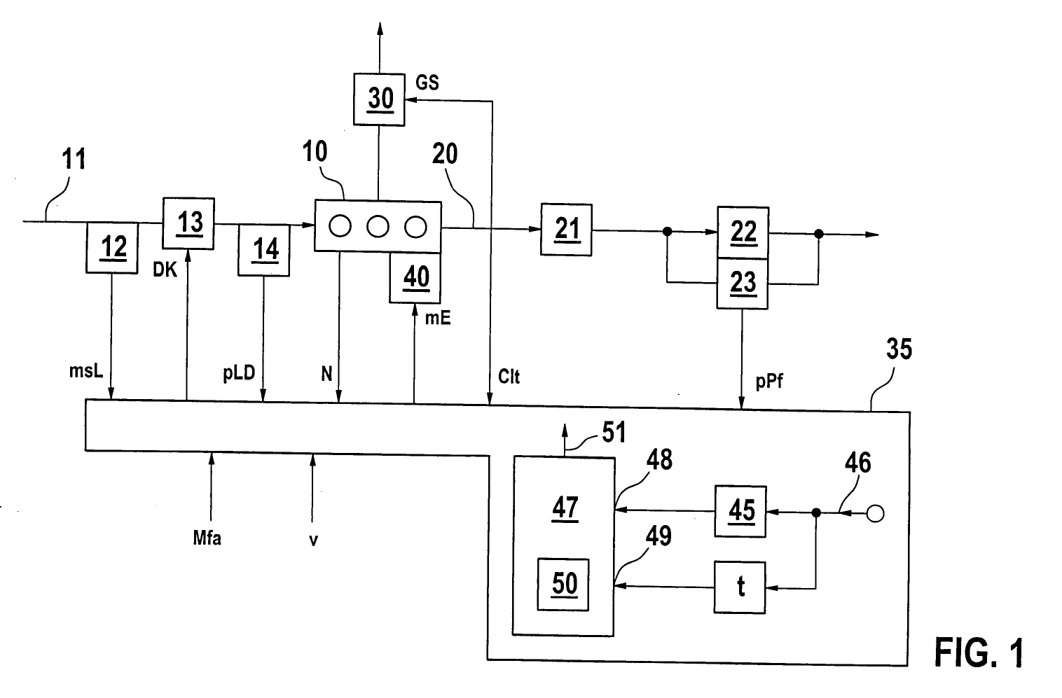

FIG. 1 shows an internal combustion engine 10 having an intake tract 11 in which are located an air sensor 12, a throttle valve 13 as well as a boost pressure sensor 14.

Located in an exhaust tract 20 of internal combustion engine 10 is a catalyst 21, a particulate filter 22 as well as a loading pressure sensor 23. Catalyst 21 and particulate filter 22 form an exhaust gas treatment device 24.

Internal combustion engine 10 is connected to a transmission 30, which is supplied with a transmission control signal GS from a control system 35.

Control system 35 is provided with an air signal msL from air sensor 12, a boost pressure signal pLD from boost pressure sensor 14, a rotational speed N from internal combustion engine 10, a power transmission signal Clt from transmission 30, and a loading pressure signal pPF from loading pressure sensor 23.

Moreover, control system 35 is supplied with a desired torque value Mfa and a velocity signal v.

Control system 35 delivers a fuel signal mE to a fuel supply device 40 associated with internal combustion engine 10, and a throttle valve signal DK to throttle valve 13.

Control system 35 includes a signal evaluator 45 and a timer t, which are supplied with an operative mode change request 46. A mode changer 47 is supplied with a mode change enable signal 48 from signal evaluator 45 and a time expiration signal 49 from timer t.

Mode changer 47 includes a mode change control 50 and provides a mode change signal 51.

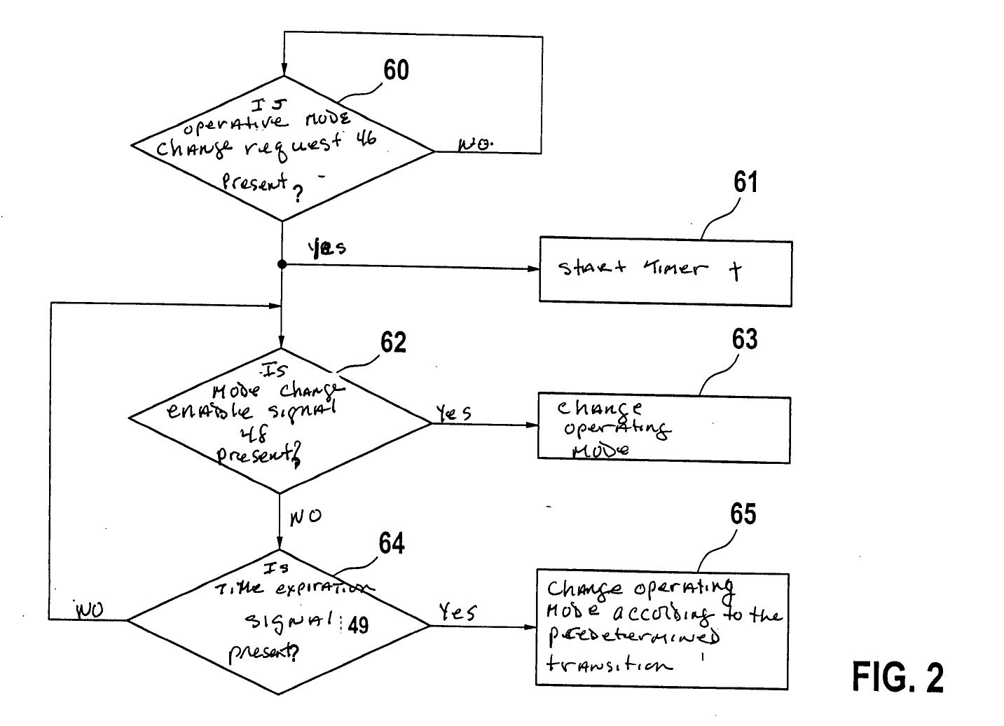

FIG. 2 illustrates the operation of the method according to the present invention.

In a first query 60, a check is made whether an operative mode change request 46 is present. If this is not the case, first query 60 is repeated. If this is the case, timer t is started in a first functional block 61. Moreover, second query 62 checks whether mode change enable signal 48 is present. If this is the case, the operative mode change is made immediately in a second functional block 63 by providing mode change signal 51. If this is not the case, the system checks in a third query 64 whether time expiration signal 49 is present. If this is the case, the operating mode is changed in a third functional block 65 according to a predetermined transition. If this is not the case, the system loops back to query 62.

The method of the present invention operates as follows:

Control system 35 determines fuel signal mE at least as a function of desired torque value Mfa, which depends on a position of an accelerator pedal (not shown) of a motor vehicle. In some instances, air signal msL provided by air sensor 12 and/or rotational speed N of internal combustion engine 10 and/or boost pressure signal pLD provided by boost pressure sensor 14 can also be taken into account.

The torque delivered by internal combustion engine 10 is provided to a drive train (not specifically shown) of a motor vehicle via transmission 30.

The exhaust gas carried in the at least one exhaust tract 20 of internal combustion engine 10 is treated by exhaust gas treatment device 24 to remove at least one undesired exhaust gas component. Exhaust gas treatment device 24 includes, for example, at least one catalyst 21 and/or a particulate filter 22. If catalyst 21 is designed as a storage catalyst, it needs to be regenerated from time to time. Particulate filter 22 must also be regenerated as a function of the loading condition.

The loading condition of the storage catalyst can be determined, for example, from a model of catalyst 21 and measured or calculated exhaust gas parameters. The loading condition of particulate filter 22 can also be determined from measured or calculated exhaust gas parameters. Alternatively or additionally, the loading condition of the particulate filter can be determined from loading pressure signal pPF, which is provided by loading pressure sensor 23. Loading pressure sensor 23 preferably measures at least the exhaust gas pressure occurring upstream of particulate filter 22. If loading pressure sensor 23 is designed as a differential pressure sensor, the exhaust gas pressure occurring downstream of particulate filter 22 can be calculated, at least approximately.

When the loading condition of catalyst 21 and/or of particulate filter 22 exceeds a predetermined threshold value, regeneration must be initiated. The end of the regeneration process can be determined in the same manner. In both cases, operative mode change request 46 is generated.

In the exemplary embodiment shown, it is assumed that the regeneration is carried out by intervening in the control of internal combustion engine 10. In this case, a torque jump can occur in internal combustion engine 10. The alternative procedure of introducing at least one reagent directly into exhaust tract 20 is in principle possible, but will not be discussed further hereinafter.

In first query 60, a check is made whether operative mode change request 46 is present. If this is not the case, first query 60 is repeated. If this is the case, timer t is started according to first functional block 61. Moreover, operative mode change request 46 is supplied to signal evaluator 45.

Signal evaluator 45 evaluates a parameter that makes it possible draw a conclusion about the operating state of internal combustion engine 10 and/or about the driving state of a motor vehicle powered by internal combustion engine 10.

A first parameter may be a deceleration fuel cutoff of internal combustion engine 10 during which fuel supply to the individual cylinders of internal combustion engine 10 is cut off completely or at least almost completely. A signal suitable for detecting the deceleration fuel cutoff is, for example, fuel signal mE and/or desired torque value Mfa. Signal evaluator 45 checks whether desired torque value Mfa and/or fuel signal mE are at least approximately zero. If this is the case, mode change enable signal 48 is provided which, according to second functional block 63, immediately causes a change in operating mode.

Mode change enable signal 48 is supplied to mode changer 47 which intervenes in the control of internal combustion engine 10 by means of mode change signal 51. Mode change signal 51 can, for example, cause throttle valve 13 to be driven in the direction of closure by means of throttle valve signal DK. Alternatively or additionally, provision can be made to reduce the boost pressure provided by a turbocharger (not specifically shown). The boost pressure is measured by boost pressure sensor 14, which provides boost pressure signal pLD. Alternatively or additionally, it is possible to retard the timing of a main fuel injection by means of fuel signal mE. Alternatively or additionally, fuel signal mE can be used to cause at least one post-injection of fuel. If internal combustion engine 10 is a spark ignition internal combustion engine, it is possible to retard the ignition timing.

All measures are aimed at either directly increasing the exhaust gas temperature, or introducing at least one reagent, such as unburned fuel, into exhaust gas tract 20; the reagent being used in an exothermic reaction to heat either the exhaust gas or directly the exhaust gas treatment device 24.

As an alternative or additional parameter, signal evaluator 45 can detect a shift of gears in transmission 30. If transmission 30 is an automatic transmission, power transmission signal Clt is available immediately. In the case of a manual transmission, power transmission signal Clt must be provided separately. For example, it is possible to use a clutch signal.

As an alternative or additional parameter, signal evaluator 45 can evaluate the load condition of internal combustion engine 10 and check whether an upper limit of the load condition is exceeded. The load condition of internal combustion engine 10 can be determined, for example, from fuel signal mE and rotational speed N. In addition, the gear engaged in transmission 30 can be taken into account, if applicable. Possibly, vehicle velocity v can also be taken into account. Consideration of this parameter is based on the assumption that during a high load condition, such as full load, a high exhaust gas temperature is present anyway so that the operative mode change will not result in a significant torque jump of internal combustion engine 10 and can be made immediately.

As an alternative or additional parameter, signal evaluator 45 can detect a dynamic process of internal combustion engine 10 or of the motor vehicle as a whole. For example, provision can be made to detect a change in desired torque value Mfa in the form of a rise time or a derivative. In practice, the derivative can be approximated by at least one difference quotient. In this embodiment, it is preferred to additionally take into account the velocity v of the motor vehicle. Velocity v and, possibly, the additional consideration of the engaged gear, can be used as a basis for suppressing an operative mode change because when vehicle velocity v is high and the load is relatively small, the drive train operates with reduced dynamics, during which a torque jump of internal combustion engine 10 would be clearly perceptible.

Other parameters for determining the dynamics are rotational speed N and/or vehicle velocity v. Preferably, signal evaluator 45 determines the gradient by at least one calculation of a difference quotient.

If at least one of the conditions is satisfied, second query 62 will detect the presence of mode change enable signal 48, which immediately causes a change in operating mode. If mode change enable signal 48 is not present, third query 64 checks whether time expiration signal 49 of timer t is present. If this is not the case, second query 62 continues to check whether appropriate conditions exist for immediate operative mode change. If third query 64 detects the presence of time expiration signal 49, functional block causes the operating mode to be changed according to a predetermined pattern.

Timer t outputs time expiration signal 49 when the time period specified by timer t has expired. The time period is set as a function of the urgency of the request for a regeneration of exhaust gas treatment device 24. If the regeneration is to be performed on catalyst 21, which is designed as a storage catalyst, the time period can be in the range of seconds. If the regeneration is to be performed on particulate filter 22, the time period can be in the range of minutes.

The time profile of the operative mode change is selected by mode change control 50, which is contained in mode changer 47. The operative mode change is made smoothly. Mode change control 50 provides, for example, a ramped transition from one operating mode to another. The function can, for example, be selected to take a linear (ramped) or parabolic form. The measure is aimed at distributing a possibly occurring change in the torque of internal combustion engine 10 over a time interval of, for example, several seconds so that the driver of the motor vehicle will not notice the change in operating mode even during unfavorable operating states of internal combustion engine 10 or of the motor vehicle as a whole.

1. A method for operating an exhaust gas treatment device of an internal combustion engine, the method comprising:
starting a timer in response to an operative mode change request; and
during a time period set by the timer, continuously deciding, based on an evaluation of at least one parameter, whether a change in an operating mode of the engine can be made, the operative mode change being made immediately if this is the case, and the operative mode change being made no later than when the time period set by the timer has expired.

2. The method according to claim 1, wherein the parameter is a signal indicative of a deceleration fuel cutoff of the internal combustion engine.

3. The method according to claim 1, wherein the parameter is a signal indicative of a gear change in a transmission associated with the internal combustion engine.

4. The method according to claim 1, wherein the parameter is a signal indicative of a load condition of the internal combustion engine.

5. The method according to claim 1, wherein the parameter is a signal indicative of dynamics of at least one of the internal combustion engine and a motor vehicle.

6. The method according to claim 1, further comprising using the operative mode change to one of initiate and terminate a regeneration of the exhaust gas treatment device.

7. The method according to claim 1, wherein the operative mode change to be made when the time period set by the timer has expired is made according to a predetermined transition.

8. The method according to claim 7, wherein the transition is in the form of one of a ramped and a parabolic function.

9. The method according to claim 1, further comprising, when changing the operating mode, at least one of the following:
retarding a timing of a main fuel injection;
carrying out at least one post-injection of fuel;
driving a throttle valve in a direction of closure; and
reducing a boost pressure.
